(19) United States
(12) Patent Application Publication
(10) Pub. No.: US 2004/0144577 A1
(43) Pub. Date: Jul. 29, 2004

(54) Wheel chair

(76) Inventor: Gene Anderson, Montgomery, MN (US)

Correspondence Address: Leffert Jay & Polglaze, P.A., P. O. Box 581009, Minneapolis, MN, 55458-1009, US

(21) Appl. No.: 10/759,952

(22) Filed: Jan. 16, 2004

Related U.S. Application Data
(63) Continuation of application No. 10/421,085, filed on Apr. 23, 2003.
(60) Provisional application No. 60/374,810, filed on Apr. 23, 2002.

(51) Int. Cl. B60K 1/00

(52) U.S. Cl. 180/65.2

(57) ABSTRACT

A wheel chair has a gas motor adapted to propel the wheel chair and an electric motor adapted to propel the wheel chair. A battery is connected to the electric motor for supplying electrical power to the electric motor. An alternator is coupled to the gas motor. During operation of the gas motor, the gas motor drives the alternator for causing the alternator to generate electricity. The alternator is coupled to the battery for supplying the generated electricity thereto for charging the battery. The gas motor can be used for outdoor operation and the electric motor for indoor operation or assisting the gas motor when overloaded or out of fuel. The wheel chair may include a track assembly having first and second sections that can pivot. An actuator may be used to selectively pivot the first and second sections. This helps the wheel chair to traverse steps and stairways.

### CROSS REFERENCE TO RELATED APPLICATIONS

This application is a continuation application of co-pending U.S. patent application Ser. No. 10/421,085, filed Apr. 24, 2003, entitled “WHEEL CHAIR,” which application is incorporated herein by reference and claims the benefit of the filing date of provisional application U.S. Serial No. 60/374,810, filed on Apr. 23, 2002.

### TECHNICAL FIELD

The present invention relates generally to self-propelled devices and in particular the present invention relates to self-propelled chairs.

### BACKGROUND

Self-propelled chairs enable handicapped individuals to travel limited distances with little physical exertion. Self-propelled chairs are typically propelled by battery-powered electric motors. The batteries are normally rechargeable. However, the distance that can be traveled by these chairs is limited by the charge on batteries. Moreover, power chairs are normally not designed to travel up and down stairs and usually have difficulty traveling over rough terrain, through snow, mud, sand, or the like. Many power chairs are rather unstable while traveling on inclined surfaces and over rough terrain, and can turn over. Further, power chairs usually do not absorb bumps well, which can cause discomfort to the user.

For the reasons stated above, and for other reasons stated below which will become apparent to those skilled in the art upon reading and understanding the present specification, there is a need in the art for alternative self-propelled chairs.

### SUMMARY

One embodiment of the present invention provides a wheel chair having a gas motor adapted to propel the wheel chair and an electric motor adapted to propel the wheel chair. A battery is connected to the electric motor for supplying electrical power to the electric motor. An alternator is coupled to the gas motor. During operation of the gas motor, the gas motor drives the alternator for causing the alternator to generate electricity. The alternator is coupled to the battery for supplying the generated electricity thereto for charging the battery.

Another embodiment provides a self-propelled device having first and second track assemblies respectively disposed on first and second sides of the self-propelled device. Each of the first and second track assemblies includes a side frame having a first section disposed between second and third sections. The second and third sections are pivotally attached to the first section. A first wheel is rotatably attached to the second section of the side frame, and a second is rotatably attached to the third section of the side frame. A track is disposed around the first and second wheels, thereby interconnecting the first and second wheels. First and second actuators are respectively connected to the second and third sections of the side frame for selectively pivoting the second and third sections of the side frame. A prime mover is adapted to propel the at least one of the first and second wheels and thus the track.

Further embodiments of the invention include methods and apparatus of varying scope.

### BRIEF DESCRIPTION OF THE DRAWINGS

FIG. 1 illustrates a control and drive mechanism for a wheel chair according to an embodiment of the present invention.

FIG. 2A illustrates a motor configuration according to another embodiment of the present invention.

FIG. 2B illustrates a motor configuration according to another embodiment of the present invention.

FIG. 2C illustrates a motor configuration according to yet another embodiment of the present invention.

FIG. 2D illustrates a motor configuration according to yet another embodiment of the present invention.

FIG. 3 is a side view of a wheel chair according to another embodiment of the present invention.

FIG. 4 is a front view of the wheel chair of FIG. 3.

FIG. 5 is a side view of a track assembly according to another embodiment of the present invention.

FIG. 6 is a perspective view of a wheel chair in use according to another embodiment of the present invention.

FIGS. 7 and 8 are side views illustrating operation of a track assembly according to another embodiment of the present invention.

FIGS. 9A and 9B illustrate a side frame of a track assembly according to another embodiment of the present invention.

FIGS. 10 and 11 are side views illustrating operation of a track assembly according to yet another embodiment of the present invention.

FIG. 12 illustrates a modular unit according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

An embodiment of the present invention is directed toward a wheel chair that provides increased maneuverability and control. In one illustrative embodiment, the wheel chair includes a motor (e.g. gas or electric) that indirectly drives one or more drive wheels of the wheel chair through one or more pneumatic (e.g., hydraulic) pumps and/or one or more pneumatic (e.g., hydraulic) motors. The amount of power that is delivered to each drive wheel may be controlled by one or more electro-pneumatic (or electro-hydraulic) transducers. A controller may be used to provide control signals to the one or more electro-pneumatic transducers. In some embodiments, the electro-pneumatic transducers may be some other type of pneumatic transducer, such as an optical- or a pressure-controlled pneumatic transducer.

In other embodiments, the electro-pneumatic transducers are electrically controllable valves or manifolds. During use, the controller may receive one or more control signals from, for example, a joystick, one or more control levers, and/or any other type of input control device. The electro-pneumatic transducers may then selectively provide pneumatic (or hydraulic) power provided by the one or more pneumatic pumps to one or more pneumatic motors that are coupled to the drive wheels of the wheel chair. By providing power to the one or more drive wheels of the wheel chair using one or more pneumatic (e.g. hydraulic) pumps and/or pneumatic motors, rather than directly off the motor or the like, increased control may be achieved.

In some embodiments, a gas motor and/or electric motor may be used to power the wheel chair. The gas motor may be any type of gas motor, including a conventional gas motor, a diesel motor, a propane powered motor or any other type of gas driven motor. The motor preferably drives one or more pneumatic pump(s) via belt, shaft, or any other suitable drive mechanism. When both a gas motor and an electric motor are provided, the gas motor may drive an alternator or the like that provides electrical power to the electric motor and/or batteries that provide electrical power to the electric motor. The electric motor may then drive the one or more pneumatic pump(s) of the wheel chair. In this respect, the wheel chair, for some embodiments, is a hybrid. In some embodiments, the gas motor may drive the one or more pneumatic pump(s) of the wheel chair in some conditions, such as in outdoor conditions, while the electric motor may drive the one or more pneumatic pump(s) in other conditions, such as in indoor conditions.

To help improve maneuverability and control, it is contemplated that the wheel chair may include a track system, but this is not required. The track may include one or more drive wheels for driving the tracks, and one or more bogie wheels for absorbing bumps and stabilizing the wheel chair, particularly over rough terrain. In a preferred embodiment, the tracks are mounted between a front-mounted drive wheel and a rear-mounted free wheel. In other embodiments, however, the rear-mounted wheel may be the drive wheel, and/or both the front- and rear-mounted wheels may be drive wheels.

A first bogie wheel may be positioned behind the front mounted drive wheel. The first bogie wheel may be biased toward a downward position, but capable of traveling in an upward direction when an upward force is applied thereto. A second and a third bogie wheel may be positioned behind the first bogie wheel, but in front of the rear-mounted free wheel. The second and third bogie wheels may be mounted on each end of a support member, which pivots about a pivot point. The pivot point is preferably located between the second and third bogie wheels. The support member is preferably biased toward a center position. When a force is applied, however, the support member may pivot about the pivot point, which may help absorb bumps and stabilize the wheel chair particularly over rough terrain.

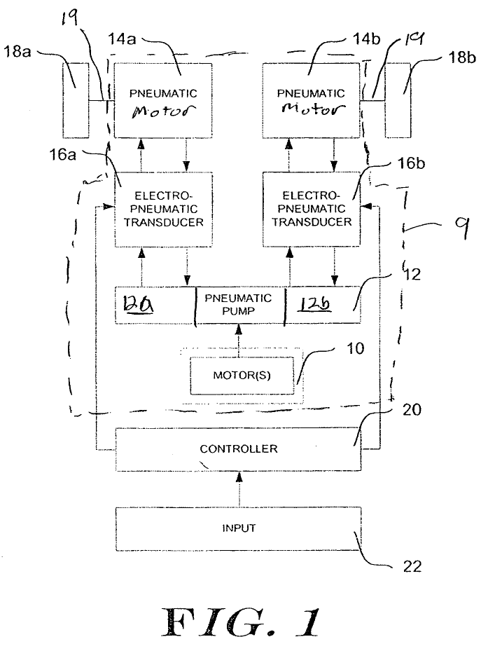

FIG. 1 is a schematic diagram showing the control and drive mechanism for an illustrative wheel chair of the present invention. For one embodiment, the illustrative chair includes a prime mover 9. For another embodiment, prime mover 9 includes one or more motor(s) 10, which drive one or more pneumatic pump(s) 12 of prime mover 9. In the illustrative embodiment, the motor 10 drives a first pneumatic pump 12a and a second pneumatic pump 12b. The pneumatic pumps 12a and 12b may be any type pneumatic pumps, including hydraulic pumps. In the illustrative embodiment, the pneumatic pumps 12a and 12b are fluidly connected to pneumatic motors 14a and 14b of prime mover 9 respectively through electro-pneumatic (or electro-hydraulic) transducers 16a and 16b of prime mover 9 and provide pneumatic (or fluid, e.g., oil, air, etc.) power (e.g. pressure or flow) to pneumatic motors 14a and 14b, through electro-pneumatic transducers 16a and 16b. The pneumatic motors 14a and 14b may be any type pneumatic motors, including hydraulic motors. For one embodiment, pneumatic motors 14a and 14b are respectively mechanically coupled to wheels 18a and 18b by shafts 19. When activated, pneumatic motor 14a provides torque to wheel 18a, and pneumatic motor 14b provides torque to wheel 18b of the wheel chair. For another embodiment, the electro-pneumatic transducers 16a and 16b are electrically controllable valves or manifolds that control the pneumatic power (e.g. pressure or flow) that is delivered from the pneumatic pumps 12a and 12b to pneumatic motors 14a and 14b. Hereinafter, pneumatic will be taken to mean any type of fluid, including a gas, such as air, a liquid, such as oil, etc.

Controller 20 may receive control inputs from input device 22. The input device 22 may be a joystick, control levers, or any other type of input control device or mechanism. The link between the input device 22 and the controller 20 may be a direct (or hardwired) electrical connection, a wireless connection, an optical connection, or any other type of communications link.

For one embodiment, the controller 20 includes a micro-controller or another data processing device that receives input control signals from the input device 22, and generates appropriate control signals for electro-pneumatic transducers 16a and 16b. In another embodiment, the controller 20 is a micro-controller that is programmed to provide appropriate control signals to pneumatic motors 14a and 14b, depending on the input control signals received from input device 22.

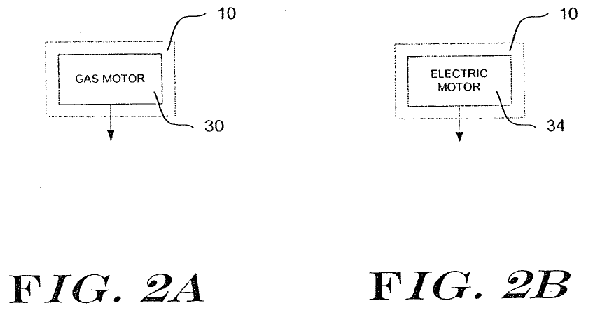

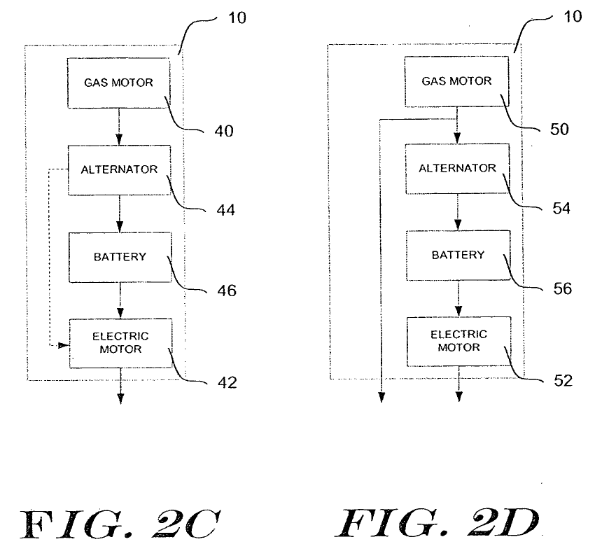

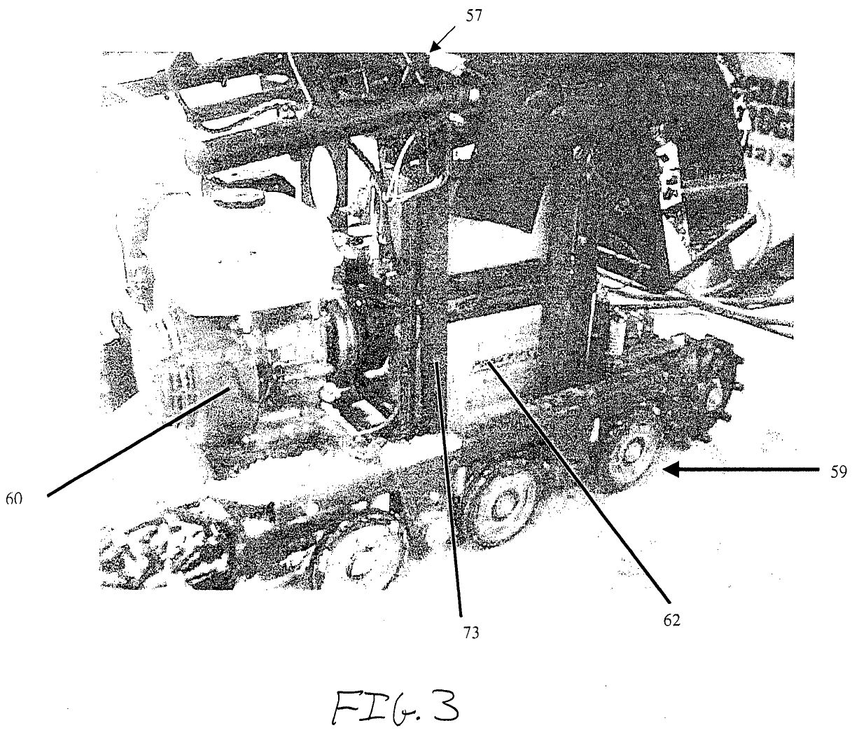

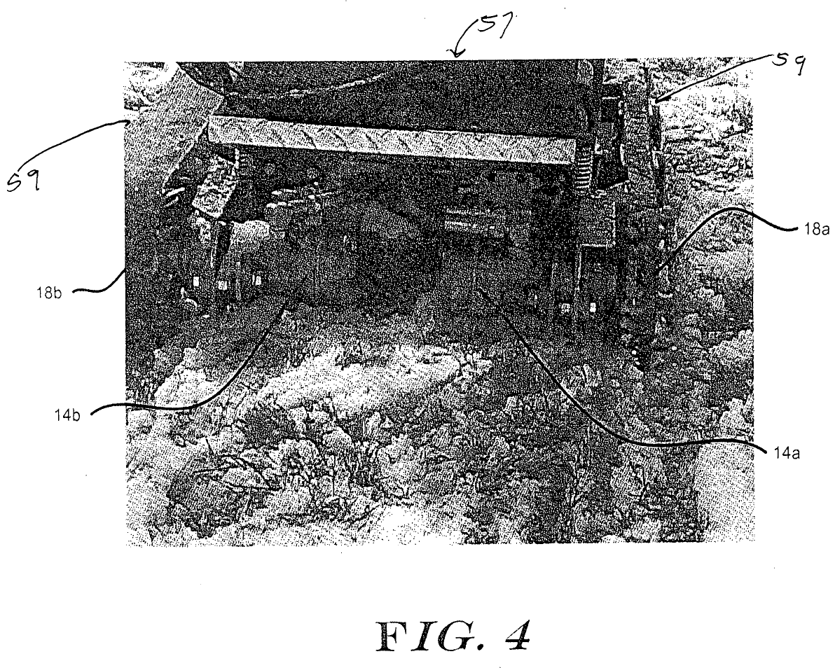

FIG. 2A is a schematic diagram showing one illustrative motor configuration in accordance with the present invention. In this illustrative embodiment, the motor 10 (see FIG. 1) includes a gas motor 30. The gas motor 30 may be any type of gas motor, including a conventional gas motor (e.g., a spark-ignition motor), a diesel motor (e.g., a compression-ignition motor), a propane-powered motor or any other type of gas driven motor. The gas motor 30 drives one or more pneumatic pumps 12a and 12b of the wheel chair via belt, shaft, or any other suitable drive mechanism. FIG. 2B is a schematic diagram showing another illustrative motor configuration in accordance with the present invention. In this illustrative embodiment, the motor 10 (see FIG. 1) includes an electric motor 34. In this embodiment, the electric motor 34 drives one or more pneumatic pumps 12a and 12b of the wheel chair via belt, shaft, or any other suitable drive mechanism.

FIG. 2C is a schematic diagram showing yet another illustrative motor configuration in accordance with the present invention. In this illustrative embodiment, the motor 10 (see FIG. 1) includes a gas motor 40 and an electric motor 42. The gas motor 40 drives an alternator 44 or the like that provides electrical power to the electric motor 42 and/or batteries 46 that provide electrical power to the electric motor 42. Therefore, for one embodiment, the wheel chair is a hybrid device. In some embodiments, the alternator 44 also charges the batteries 46 for later use. In another embodiment, electric motor 42 can be used to start gas motor 40. For some embodiments, electric motor 42 and alternator 44 are integral and are contained in a single unit. A separate battery charger may also be provided to charge the batteries 46 using an external AC power source. The electric motor 42 then drives one or more pneumatic pumps 12a and 12b of the wheel chair via belt, shaft, or any other suitable drive mechanism.

FIG. 2D is a schematic diagram showing another illustrative motor configuration in accordance with the present invention. In this illustrative embodiment, the motor 10 (see FIG. 1) includes a gas motor 50 and an electric motor 52. The gas motor 50 drives the one or more pneumatic pumps 12a and 12b of the wheel chair in some conditions, such as in outdoor conditions, while the electric motor 52 drives the one or more pneumatic pumps 12a and 12b of the wheel chair in other conditions, such as in indoor conditions, when the gas motor runs out of fuel, etc. The gas motor 50 may also drive an alternator 54 or the like to charge the batteries 56 for later use. For another embodiment, e.g., if gas motor becomes overloaded, electric motor 52 can be used to assist gas motor 50. For some embodiments, electric motor 52 and alternator 54 are integrated to form a single unit.

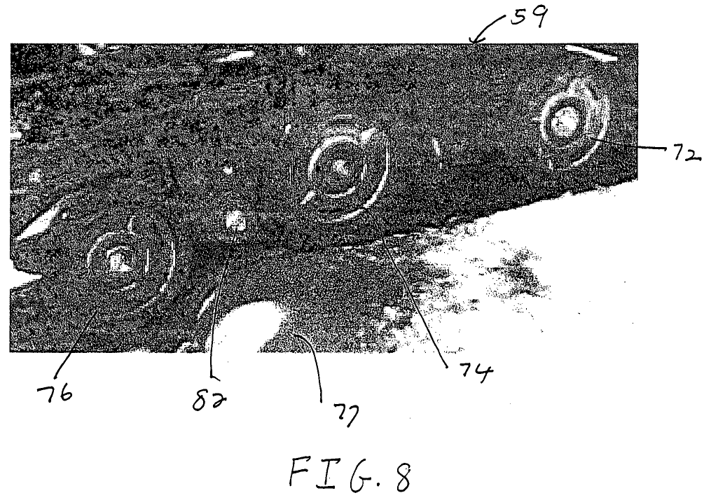

FIG. 6 is a perspective view illustrating a wheel chair 57 in use according to another embodiment of the present invention. For one embodiment, wheel chair 57 includes a track system 58, e.g., to help improve maneuverability and control of the wheel chair. For another embodiment, track system 58 includes a track assembly 59 disposed on either side of wheel chair 57, as shown in FIG. 6. Each track assembly 59 includes a track 63 that in one embodiment is a flexible belt formed into a loop. For another embodiment, wheel chair 57 includes a seat 55 for a user.

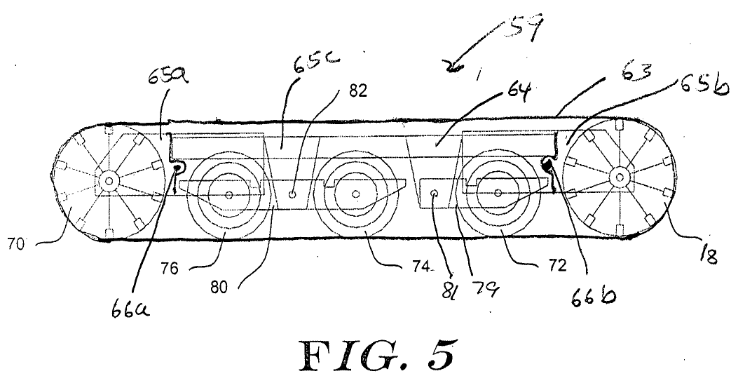

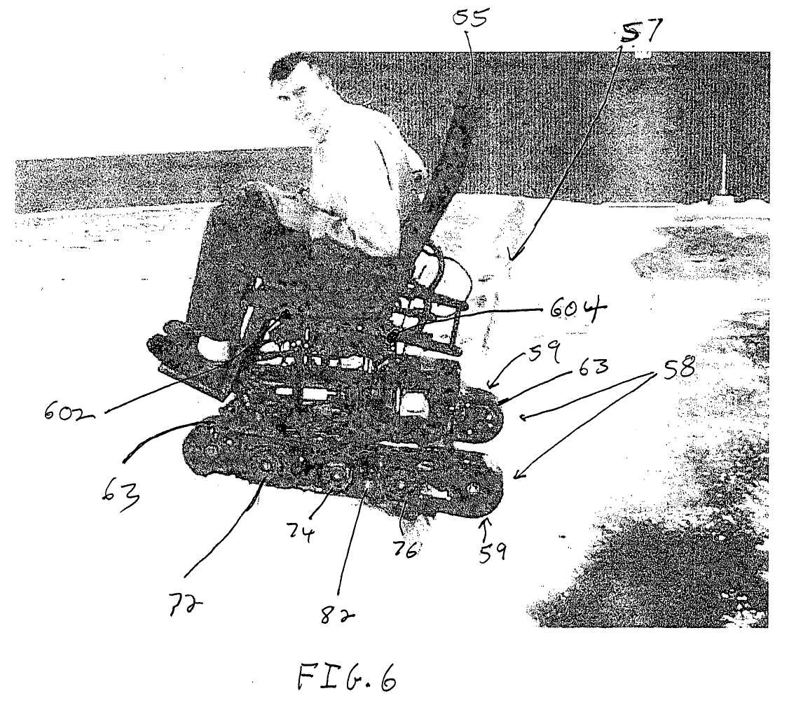

FIG. 3 is a side view of wheel chair 57 in accordance with another embodiment of the present invention. Wheel chair 57 includes a gas motor 60 mounted to a frame 73. The gas motor 60 drives an alternator, such as alternator 44 or 54 respectively of FIGS. 2C or 2D, which drives an electric motor. A number of batteries 62 are also provided so that the electric motor can be used when the gas motor 60 is turned off (e.g., during indoor operation), runs out of gas, needs assistance, etc. The electric motor drives one or more pneumatic pumps 12a and 12b, shown in FIG. 1, which provide pneumatic power to pneumatic motors 14a and 14b (see FIG. 4 a front view of wheel chair 57) through electro-pneumatic transducers 16a and 16b, shown in FIG. 1, respectively. Pneumatic motor 14a provides torque to a first wheel 18a, and pneumatic motor 14b provides torque to a second wheel 18b of the wheel chair. As noted above, the electro-pneumatic transducers 16a and 16b may be electrically controllable valves or manifolds that may control the pneumatic power that is delivered from the one or more pneumatic pumps 12a and 12b to pneumatic motors 14a and 14b. Note that track 63 is removed from one of the track assemblies 59 in FIG. 4 and the corresponding track assembly 59 in FIG. 3.

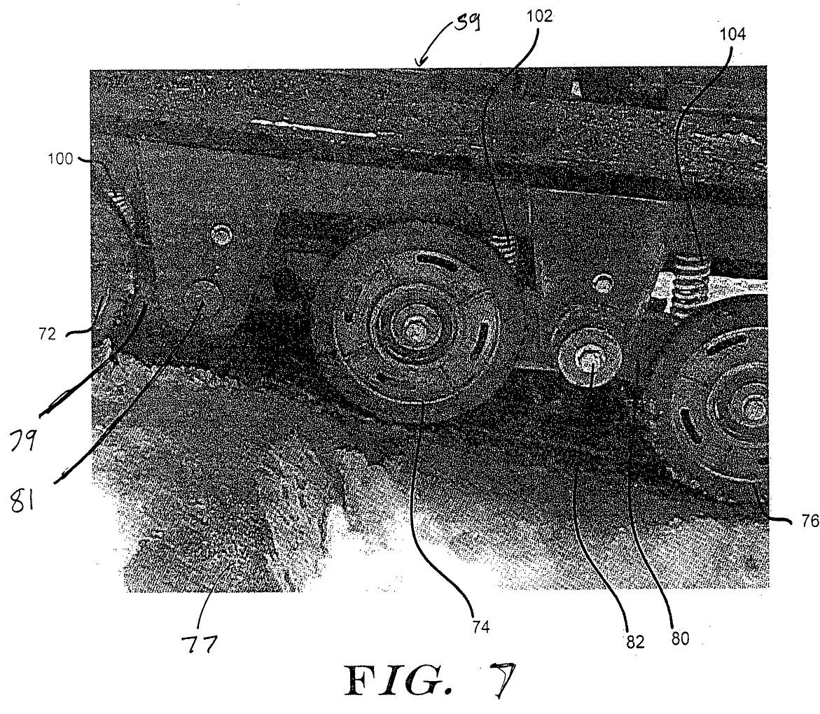

As best seen in FIG. 5, for one embodiment, track assembly 59 includes a side frame 64 having one of drive wheels 18 rotatably mounted thereon for driving track 63, and a free wheel 70 rotatably mounted thereon. Track 63 is mounted between drive wheel 18 and free wheel 70. More specifically, track 63 wraps around drive wheel 18 and free wheel 70, as shown in FIG. 5. For another embodiment, drive wheel 18 is located at a front of wheel chair 57 and free wheel 70 at the rear.

For some embodiments, three bogie wheels 72, 74, and 76 are also provided between drive wheel 18 and free wheel 70, and are connected to side frame 64. The three bogie wheels 72, 74, and 76 may help absorb bumps and stabilize wheel chair 57, particularly over rough terrain. For one embodiment, bogie wheel 72 is positioned behind drive wheel 18. For another embodiment, bogie wheel 72 is biased in a downward position, against track 63, and is configured to travel in an upward direction when an upward force is applied. For some embodiments, bogie wheel 72 is rotatably attached to a bracket 79 that is pivotally attached to side frame 64 at a pivot 81.

Bogie wheels 74 and 76 are positioned between bogie wheel 72 and free wheel 70. For one embodiment, bogie wheel 72 is positioned below or near the front of seat 55 of FIG. 6, and bogie wheels 74 and 76 are positioned below or near the rear of seat 55. This may help stabilize the wheel chair when traversing rough terrain. More specifically, for another embodiment, bogie wheel 72 is substantially aligned with a point 602 near the front of seat 55, and a pivot point (or pivot) 82 located between bogie wheels 74 and 76 is substantially aligned with a point 604 just behind seat 55, as shown in FIG. 6.

For one embodiment, pivot 82 pivotally attaches a support member 80 to side frame 64, as shown in FIG. 5. For another embodiment, bogie wheel 74 and bogie wheel 76 are mounted on each end of support member 80 that can pivot about pivot point 82. Support member 80 may be biased toward a center position, against track 63, e.g., so that support member is substantially parallel to side frame 64, as shown in FIG. 5. When a force is applied to the bottoms of bogie wheels 74 and 76, the support member 80 may pivot about the pivot point 82 to help absorb bumps and stabilize the wheel chair, particularly over rough terrain.

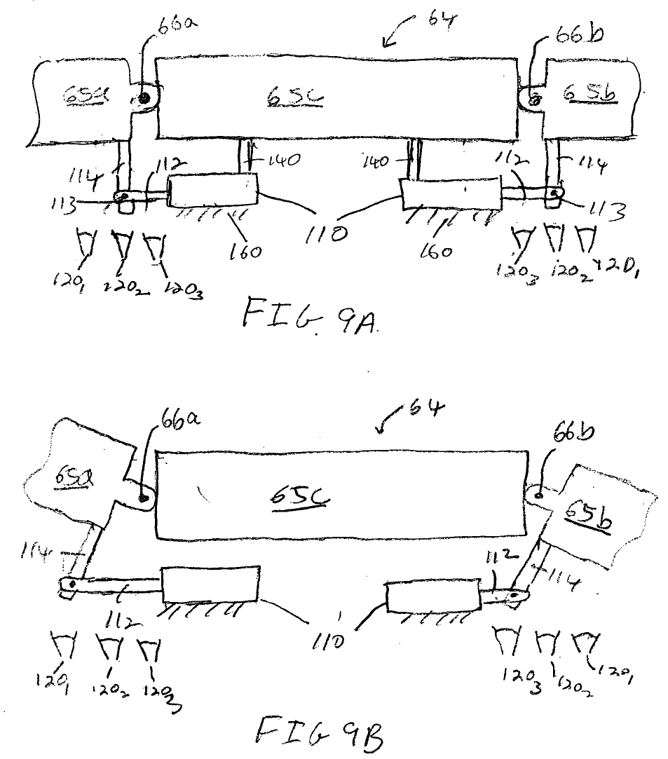

FIGS. 7 and 8 are side views illustrating operation of track assembly 59 as wheel chair 57 travels over a curb (or step) 77 according to another embodiment of the present invention. FIG. 7 shows bogie wheel 72 atop step 77 as wheel chair 57 travels up step 77. Bogie wheel 76 is below step 77; member 80 is pivoted about the pivot point 82; and bogie wheel 74 is near the top of step 77. FIG. 8 shows bogie wheel 76 below step 77; member 80 pivoted further about the pivot point 82; and bogie wheel 74 atop step 77. Pivoting support member 80 about the pivot point 82 helps absorb bumps and stabilize the wheel chair when traveling up or down step 77.

Specifically, when bogie wheel 72 encounters step 77, as wheel chair moves up step 77, step 77 exerts a force on bogie wheel 72 that pivots bracket 79 about pivot 81, causing bogie wheel 72 to move upward. This helps to absorb bumps and stabilize the wheel chair when traveling up step 77. Conversely, when bogie wheel moves past step 77, as wheel chair moves down step 77, bogie wheel 72 is pivoted downward into its biased position (not shown). This helps to absorb bumps and stabilize the wheel chair when traveling down step 77. When bogie wheel 74 encounters step 77, as wheel chair moves up step 77, step 77 exerts a force on bogie wheel 74 that moves bogie wheel 74 upward, pivoting support member 80 about pivot 82, as shown in FIGS. 7 and 8. This acts to keep bogie wheel 76 at or near the bottom of step 77. For another embodiment, when bogie wheel 76 moves past step 77, as wheel chair moves down step 77, a force exerted on bogie wheel 76 by step 77 is removed while step 77 still exerts a force on bogie wheel 74. This pivots support member 80 about pivot 82 and moves bogie wheel 76 to the bottom of step 77.

As noted above, bogie wheel 72, for one embodiment, is biased toward a downward position, but is configured to travel in an upward direction when an upward force is applied thereto. As shown in FIG. 7, the downward bias may be provided by a spring 100. Likewise, the support member 80 may be biased toward a center position, as described above. This centering bias may be provided by springs 102 and 104. While springs are shown in FIG. 7, it is contemplated that any suitable bias means may be used.

For one embodiment, side frame 64 includes sections 65a, 65b, and 65c, where section 65c is disposed between sections 65a and 65b, as shown in FIG. 5. Sections 65a and 65b are respectively pivotally attached to section 65c at pivots 66a and 66b. For another embodiment, free wheel 70 and drive wheel 18 are respectively rotatably mounted on sections 65a and 65b. In this way, free wheel 70 and drive wheel 18 can be selectively pivoted about pivots 66a and 66b, e.g., while wheel chair 57 traverses steps of a stairway, step 77, etc. For another embodiment, bracket 79 and support member 80 are pivotally attached to section 65c.

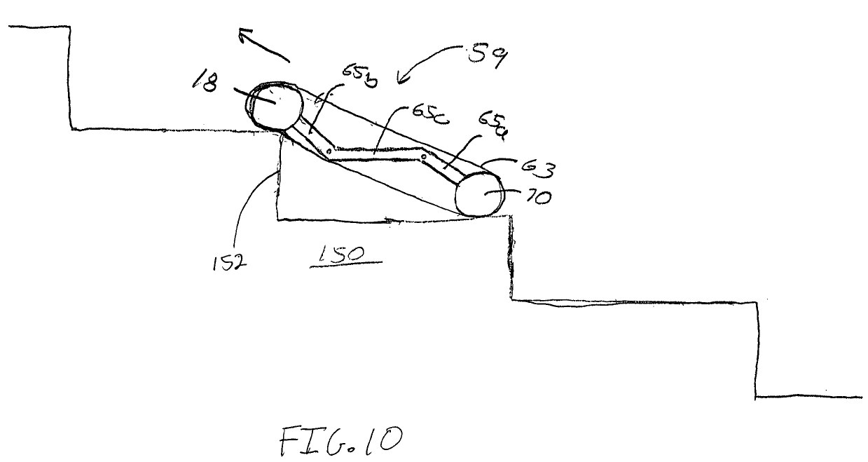

FIGS. 9A and 9B illustrate pivoting of sections 65a and 65b of side frame 64 relative to section 65c of side frame 64 according to another embodiment of the present invention. For one embodiment, an actuator 110 is connected to each of sections 65a and 65b. Specifically, in this embodiment, a rod 112 of one of actuators 110 is pivotally connected at a pivot 113 to an arm 114 that is fixedly connected to one of sections 65a or 65b, as shown in FIG. 9A. Actuators 110 selectively retract or extend rods 112 to pivot sections 65a and 65b. For example, extending rod 112 causes section 65a or 65b to pivot upward, as illustrated for section 65a in FIG. 9B, and retracting rod 112 causes section 65a or 65b to pivot downward, as illustrated for section 65b in FIG. 9B. As rod 112 is extended or retracted, a force is exerted on arm 114, causing arm 114 to pivot about pivot 113 while causing section 65a or 65b to pivot. For one embodiment, actuators 110 are fixedly attached to a frame 160 disposed between side frames 64 of track assemblies 59. For another embodiment, brackets 140 fixedly attach actuators 110 to section 65c. It will be appreciated by those skilled in the art that a variety of different methods and apparatus can be employed for pivoting sections 65a and 65b.

For one embodiment, each actuator 110 includes an electric motor geared to rod 112, such as by worm-and-pinion gearing, rack-and-pinion gearing, etc., for causing rod 112 to extend and retract. For another embodiment, actuator 110 is connected to controller 20 of FIG. 1 for control thereby and is powered by batteries 62 of FIG. 3. For yet another embodiment, the user of wheel chair 57 can selectively control actuators 110, e.g., by buttons on input device 22. For other embodiments, the electric motor is a stepper motor, and controller 20 counts the number of steps from a neutral position, e.g., where the corresponding one of sections 65a or 65b is not pivoted as in FIG. 9A, to determine the angular location of the corresponding one of sections 65a and 65b.

For some embodiments, optical sensors 120₁ to 120₃ (shown in FIGS. 9A and 9B) detect the position of arm 114 and thus an angular location of section 65a or 65b. For one embodiment, optical sensors are attached to frame 160. For another embodiment, when optical sensor 120₂ is aligned with arm 114, as shown in FIG. 9A, the corresponding one of sections 65a or 65b is the neutral position and is substantially parallel with section 65c. When optical sensor 120₁ is aligned with arm 114, for example, the corresponding one of sections 65a or 65b is pivoted upward as far as possible, as illustrated for section 65a in FIG. 9B. For one embodiment, when arm 114 aligns with optical sensor 120₁, optical sensor 120₁ sends a signal to controller 20. In response to the signal, controller 20 causes actuator 110 to stop. However, the user can selectively stop actuator 110, and thus pivoting of the corresponding section, at any point between the neutral and fully upward position from input device 22.

When optical sensor 120₃ is aligned with arm 114, for example, the corresponding one of sections 65a and 65b is pivoted downward as far as possible, as illustrated for section 65b in FIG. 9B. For one embodiment, when arm 114 aligns with optical sensor 120₃, optical sensor 120₃ sends a signal to controller 20. In response to the signal, controller 20 causes actuator 110 to stop. However, the user can selectively stop actuator 110, and thus pivoting of the corresponding section, at any point between the neutral and fully downward position from input device 22. When arm 114 aligns with optical sensor 120₂, optical sensor 120₂ sends a signal to controller 20 that informs controller 20 that the corresponding one of sections 65a and 65b is in the neutral position and an indicator, such as a lamp, informs the user that the corresponding one of sections 65a and 65b is in the neutral position.

For some embodiments, sensors 120 detect an indicator on rod 112 for determining when the corresponding one of sections 65a or 65b is in the neutral position, pivoted fully upward, or pivoted fully downward. For one embodiment, rod 112 engages a switch disposed with actuator 110 when the corresponding one of sections 65a and 65b is in the neutral position, pivoted fully upward, or pivoted fully downward. When contacting the switch at the fully upward or downward positions, the switch causes the actuator to stop. When contacting the switch at the neutral position, the switch causes an indicator, such as a lamp, to inform the user that the corresponding one of sections 65a and 65b is in the neutral position.

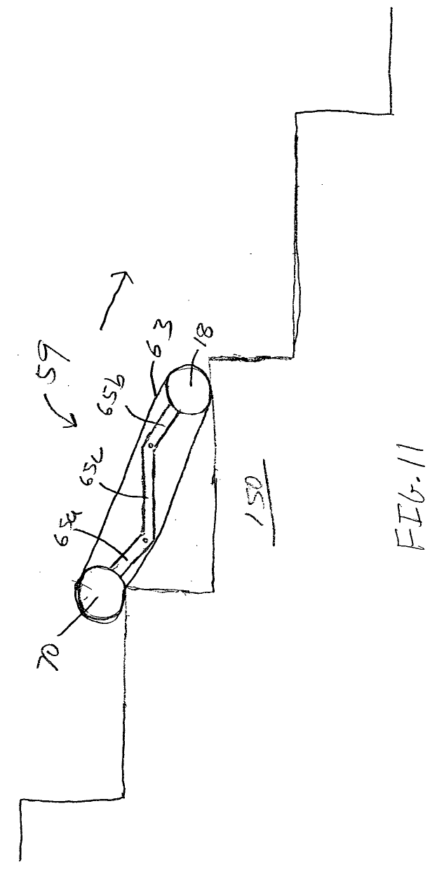

FIGS. 10 and 11 illustrate operation of one of track assemblies 59 while wheel chair 57 respectively travels up and down stairs 150 according to another embodiment of the present invention. To cause wheel chair 57 to travel up (or climb) one or more of steps 152 of stairs 150, the user pivots section 65b upward to raise drive wheel 18 and section 65a downward to lower free wheel 70, as shown in FIG. 10. For one embodiment, this causes section 65c to be substantially horizontal, as shown in FIG. 10, and thus wheel chair 57 to substantially horizontal, which acts to prevent the user of the chair from falling out of wheel chair 57 and/or wheel chair 57 from tumbling down stairs 150. Meanwhile, the user activates drive wheel 18 that causes track 63 to move and thus move wheel chair 57 over step 152 and up stairs 150.

To cause wheel chair 57 to travel down one or more of steps 152 of stairs 150, the user pivots section 65a upward to raise free wheel 70 and section 65b downward to lower drive wheel 18, as shown in FIG. 11. This causes wheel chair 57 to be substantially horizontal, for one embodiment, as described above. Meanwhile, the user activates drive wheel 18 that causes track 63 to move and thus move wheel chair 57 down stairs 150.

Drive wheel 18 also can apply braking to track 63 to prevent wheel chair 57 from traveling down stairs 150 too fast. For various embodiments, bogie wheels 72, 74, and 76 (not shown in FIGS. 10 and 11) operate as shown in FIGS. 7 and 8 and described above as wheel chair 57 travels up or down each of steps 152.

For one embodiment, sections 65a and 65b are maintained in the neutral position when wheel chair 57 is traveling over a substantially flat surface. The user activates drive wheel 18 that causes track 63 to move and thus move wheel chair 57 over the substantially flat surface. For other embodiments, each of actuators 110 locks (or maintains) the corresponding one of sections 65a and 65b at a selected angular position when the actuator is not moving the corresponding one of sections 65a and 65b.

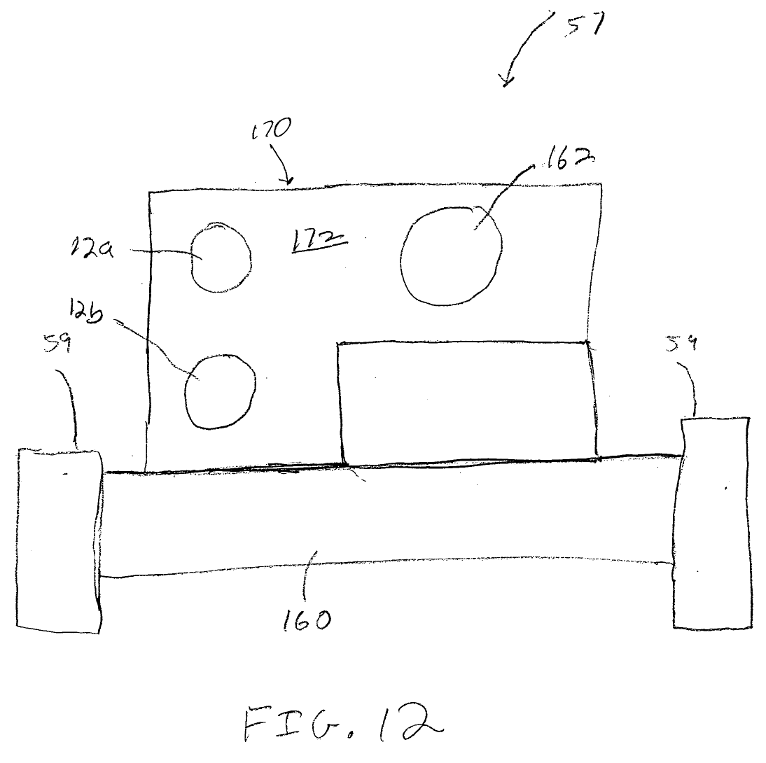

For one embodiment, wheel chair 57 includes a modular unit 170, as shown in FIG. 12. For some embodiments, modular unit 170 includes a plate 172 having pumps 12a and 12b and an electric motor 162 mounted thereon. Plate 170 is removably attached to the frame 160, e.g., by bolting, screwing, or the like. Modular unit 170 enables pumps 12a and 12b and electric motor 162 to be removed, shipped, and/or installed as a single unit, for example, and thus facilitates repair of wheel chair 57.

For some embodiments, wheel chair 57 can operate as a mobile robot. For example, for some embodiments, a wireless link couples input device 22 to controller 20, and a user can control wheel chair 57 from a remote location. For one embodiment, seat 55 of wheel chair 57, as shown in FIG. 6, is replaced by containers, such as for containing mail, packages, or the like. For another embodiment, a ram, a gun, etc. replaces seat 55, e.g., for law-enforcement applications. Moreover, the mobile robot can be used for firefighting applications, e.g., the mobile robot can be used to traverse burning buildings, etc. For some embodiments, the mobile robot is fitted with cameras for sending pictures to a user at a remote location. For one embodiment, controller 20 is preprogrammed to perform various tasks without user intervention. For another embodiment, a user may select a program from input device 22.

### Conclusion

Embodiments of the present invention provide self-propelled devices, such as wheel chairs. For one embodiment, a wheel chair is a hybrid device and has a gas motor adapted to propel the wheel chair and an electric motor adapted to propel the wheel chair. A battery is connected to the electric motor for supplying electrical power to the electric motor. An alternator is coupled to the gas motor. During operation of the gas motor, the gas motor drives the alternator for causing the alternator to generate electricity. The alternator is coupled to the battery for supplying the generated electricity thereto for charging the battery. The gas motor can be used for outdoor operation and the electric motor for indoor operation or assisting the gas motor when overloaded or out of fuel.

For another embodiment, a self-propelled device includes a track assembly having first and second sections pivotally attached to a third section. An actuator may be used to selectively pivot the first and second sections. A track is disposed around a first wheel rotatably attached to the first section and a second wheel rotatably attached to the second section. A prime mover drives at least one of the first and second wheels for driving the track, which causes the self-propelled device to move. Pivoting the first and second sections helps the wheel chair to traverse steps and stairways. For some embodiments, the prime mover has a first motor coupled to a hydraulic device that is coupled to at least one of the first and second wheels. The motor is adapted to drive the hydraulic device, and the hydraulic device is adapted to supply a torque to at least one of the first and second wheels. The motor may include at least one of a gas and an electric motor. The gas motor may drive an alternator for generating electricity that can be stored in batteries for use by the electric motor.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A wheel chair comprising:
a gas motor adapted to propel the wheel chair;
an electric motor adapted to propel the wheel chair;
a battery connected to the electric motor for supplying electrical power to the electric motor; and
an alternator coupled to the gas motor, wherein during operation of the gas motor, the gas motor drives the alternator for causing the alternator to generate electricity, wherein the alternator is coupled to the battery for supplying the generated electricity thereto for charging the battery.

2. The wheel chair of claim 1, wherein the gas motor is a diesel motor or a propane-powered motor.

3. The wheel chair of claim 1, and further comprising a hydraulic device coupled to the gas motor and the electric motor to be driven by at least one of the gas motor and the electric motor, wherein the hydraulic device is coupled to a drive wheel of the wheel chair for driving the drive wheel.

4. The wheel chair of claim 3, wherein the hydraulic device comprises:
a hydraulic pump coupled to the gas motor and the electric motor; and
a hydraulic motor fluidly coupled to the hydraulic pump and coupled to the drive wheel for providing torque to the drive wheel.

5. The wheel chair of claim 4, wherein the hydraulic pump and the electric motor are mounted on a modular unit that is removably attached to the wheel chair.

6. The wheel chair of claim 4, wherein the hydraulic device further comprises a transducer coupled between the hydraulic pump and hydraulic motor.

7. The wheel chair of claim 3, and further comprising a track system connected to the drive wheel.

8. The wheel chair of claim 3, and further comprising a controller coupled to the hydraulic device.

9. The wheel chair of claim 8, and further comprising an input device coupled to the controller.

10. The wheel chair of claim 9, wherein the input device is wirelessly coupled to the controller.

11. The wheel chair of claim 1, and further comprising a track system adapted to propel the chair and adapted to be powered by at least one of the gas motor and the electric motor.

12. The wheel chair of claim 1, wherein the electric motor is adapted to start the gas motor.

13. The wheel chair of claim 1, wherein the electric motor and the alternator are contained in a single unit.

14. The wheel chair of claim 1, wherein the electric motor is adapted to assist the gas motor.

15. A wheel chair comprising:
first and second track assemblies respectively disposed on first and second sides of the wheel chair, each of the first and second track assemblies comprising:
a first wheel;
a second wheel;
a track disposed around the first and second wheels, interconnecting the first and second wheels;
a first bogie wheel disposed between the first and second wheels, the first bogie wheel biased in a downward position and configured to travel in an upward direction when an upward force is applied thereto; and
second and third bogie wheels disposed between the second wheel and the first bogie wheel, the second and third bogie wheels disposed on opposite ends of a support member pivotally attached to each of the first and second track assemblies, wherein the support member is biased at a center position and is configured to pivot when a force is applied to one or both of the second and third bogie wheels; and
a prime mover adapted to propel at least one of the first and second wheels and thus the track.

16. The wheel chair of claim 15, wherein the prime mover comprises a first motor coupled to a hydraulic device that is coupled to at least one of the first and second wheels, wherein the motor is adapted to drive the hydraulic device and the hydraulic device is adapted to supply a torque to at least one of the first and second wheels.

17. The wheel chair of claim 16, wherein the first motor comprises at least one of a gas motor and an electric motor.

18. The wheel chair of claim 17, wherein the first motor further comprises an alternator that is drivable by the gas motor for charging a battery of the wheel chair, the battery for supplying power to the electric motor.

19. The wheel chair of claim 15, and further comprising a controller having an input device coupled thereto, the controller further coupled to the prime mover to control the prime mover.

20. A self-propelled device comprising:
first and second track assemblies respectively disposed on first and second sides of the self-propelled device, each of the first and second track assemblies comprising:
a side frame having a first section disposed between second and third sections, wherein the second and third sections are pivotally attached to the first section;
a first wheel rotatably attached to the second section of the side frame;
a second wheel rotatably attached to the third section of the side frame; and
a track disposed around the first and second wheels, interconnecting the first and second wheels;
first and second actuators respectively connected to the second and third sections of the side frame for selectively pivoting the second and third sections of the side frame; and
a prime mover adapted to propel at least one of the first and second wheels and thus the track.

21. The self-propelled device of claim 20, wherein the prime mover comprises a first motor coupled to a hydraulic device that is coupled to at least one of the first and second wheels, wherein the motor is adapted to drive the hydraulic device and the hydraulic device is adapted to supply a torque to at least one of the first and second wheels.

22. The self-propelled device of claim 21, wherein the first motor comprises at least one of a gas motor and an electric motor.

23. The self-propelled device of claim 22, wherein the first motor further comprises an alternator that is drivable by the gas motor for charging a battery of the wheel chair, the battery for supplying power to the electric motor.

24. The self-propelled device of claim 20, and further comprising a controller having an input device coupled thereto, the controller coupled to the prime mover to control the prime mover.

25. The self-propelled device of claim 24, wherein the first and second actuators are connected to at least one of the input device and the controller.

26. The self-propelled device of claim 20, and further comprising a first bogie wheel disposed between the first and second wheels, the first bogie wheel biased in a downward position and configured to travel in an upward direction when an upward force is applied thereto.

27. The self-propelled device of claim 26, and further comprising second and third bogie wheels disposed between the second wheel and the first bogie wheel, the second and third bogie wheels disposed on opposite ends of a support member pivotally attached to the side frame, wherein the support member is biased at a center position and is configured to pivot when a force is applied to one or both of the second and third bogie wheels.

28. The self-propelled device of claim 20, wherein the first and second actuators are electrically powered.

29. The self-propelled device of claim 20, and further comprising a mechanism for determining an angular location of a respective one of the second and third sections.

30. A self-propelled device comprising:
first and second track assemblies respectively disposed on first and second sides of the self-propelled device, each of the first and second track assemblies comprising:
a side frame having a first section disposed between second and third sections, wherein the second and third sections are pivotally attached to the first section
a drive wheel rotatably attached to the second section of the side frame;
a free wheel rotatably attached to the third section of the side frame; and
a track disposed around the drive wheel and the free wheel, interconnecting the drive wheel and the free wheel;
first and second actuators respectively connected to the second and third sections of the side frame for selectively pivoting the second and third sections of the side frame;
a prime mover adapted to propel the drive wheel and thus the track;
a mechanism for determining the angular location of a respective one of the second and third sections;
a controller coupled to the prime mover and the actuators; and
an input device coupled to the controller.

31. The self-propelled device of claim 30, wherein the mechanism comprises optical sensors.

32. The self-propelled device of claim 30, wherein the mechanism comprises:
a first sensor for detecting when a respective one of the second and third sections is in a neutral position;
a second sensor for detecting when a respective one of the second and third sections is pivoted fully downward; and
a third sensor for detecting when a respective one of the second and third sections is pivoted fully upward.

33. The self-propelled device of claim 30, wherein the mechanism comprises a stepper motor.

34. The self-propelled device of claim 30, wherein the mechanism is electrically coupled to the controller.

35. A method for operating a wheel chair, the method comprising:
driving the wheel chair using a gas motor of the wheel chair during a first condition;
driving an alternator of the wheel chair using the gas motor for causing the alternator to generate electricity;
storing the generated electricity in a battery of the wheel chair; and
driving the wheel chair using an electric motor of the wheel chair during a second condition, wherein the electric motor receives electricity from the battery.

36. The method of claim 35, wherein the first condition comprises outdoor conditions and the second condition comprises indoor conditions, when the gas motor runs out of fuel, or when the gas motor needs assistance from the electric motor while the gas motor is running.

37. The method of claim 35, wherein driving the wheel chair using a gas motor comprises driving a hydraulic device using the gas motor, wherein the hydraulic device drives the wheel chair.

38. The method of claim 37, wherein driving the wheel chair using an electric motor comprises driving the hydraulic device using the electric motor.

39. The method of claim 35, wherein driving the wheel chair comprises driving a track system of the wheel chair.

40. A method for operating a self-propelled device, the method comprising:
to travel up a step, pivoting a first section of a track assembly of the self-propelled device upward to raise a first wheel rotatably attached to the first section and pivoting a second section of the track assembly downward to lower a second wheel rotatably attached to the second section, wherein a track is wrapped around the first and second wheels;
to travel down the step, pivoting the first section downward to lower the first wheel and pivoting the second section upward to raise the second wheel;
to travel over a substantially flat surface, maintaining the first and second sections at a neutral position; and
activating at least one of the first and second wheels for causing the track to move, whereby causing the self-propelled device to move up or down the step or over the substantially flat surface.

41. The method of claim 40, and further comprising pivoting a first bogie wheel disposed between the first and second wheels upward in response to the first bogie wheel encountering a top of the step when traveling up the step.

42. The method of claim 40, and further comprising returning a first bogie wheel disposed between the first and second wheels to a biased position when the first bogie wheel moves past a top of the step when traveling down the step.

43. The method of claim 40, and further comprising when traveling up the step, pivoting a support member of the track assembly in response to a first bogie wheel connected to the support member encountering a top of the step, wherein pivoting the support member causes a second bogie wheel connected to the support member to maintain contact with a bottom of the step.

44. The method of claim 40, and further comprising when traveling down the step, pivoting a support member of the track assembly in response to a first bogie wheel connected to the support member moving past a top of the step while a first bogie wheel connected to the support member remains atop the step, wherein pivoting the support member causes the first bogie wheel to contact a bottom of the step.
